(19) United States
(12) Patent Application Publication
(10) Pub. No.: US 2013/0283821 A1
(43) Pub. Date: Oct. 31, 2013

(54) GAS TURBINE ENGINE AND NACELLE NOISE ATTENUATION STRUCTURE

(71) Applicants: Jonathan Gilson, West Hartford, CT (US); Molly M. May, Manchester, CT (US); David A. Welch, Quaker Hill, CT (US); Nigel David Sawyers-Abbott, South Glastonbury, CT (US)

(72) Inventors: Jonathan Gilson, West Hartford, CT (US); Molly M. May, Manchester, CT (US); David A. Welch, Quaker Hill, CT (US); Nigel David Sawyers-Abbott, South Glastonbury, CT (US)

(21) Appl. No.: 13/459,831

(22) Filed: Apr. 30, 2012

(51) Int. Cl. F02C 3/04; F04D 29/66

(52) U.S. Cl. 60/805; 415/119

(57) ABSTRACT

A nacelle structure for a gas turbine engine assembly includes a fan case, an inlet, and a noise attenuation device. The fan case is configured to be disposed about a fan section of the gas turbine engine, which fan section has a diameter D. The inlet is attached to the fan case and extends axially forward of the fan case. A hilite of the inlet is spaced a distance L from a region in which the fan section is configured to be disposed. A ratio L/D is less than about 0.6. The noise attenuation structure covers a portion of an inner surface of the fan case and the inlet.

### STATEMENT REGARDING FEDERALLY SPONSORED RESEARCH OR DEVELOPMENT

This invention was made with government support under Contract No. DTFAWA-10-C--00041 awarded by the United States Federal Aviation Administration. The Government has certain rights in this invention.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

A nacelle surrounds the gas turbine engine and guides air into the fan section. Decoupling of the fan from the low turbine by way of the epicyclical gear assembly provides for the use of fan sections of increasing diameters. The increases in fan diameter result in a corresponding increase in nacelle diameter. The nacelle further includes acoustic treatments for reducing noise produced by operation of the engine and the fan. Larger diameter nacelles increase overall weight and noise that can detract from the benefits provided by the geared fan architectures.

Accordingly, it is desirable to develop nacelle structures that accommodate increases in fan section diameter while retaining or improving noise signature.

### SUMMARY

A gas turbine engine assembly according to an exemplary embodiment of this disclosure, among other possible things includes a fan section including a plurality of fan blades rotatable about an axis, a compressor section, a combustor in fluid communication with the compressor section a turbine section in fluid communication with the combustor, a speed change system drivable by the turbine section for rotating the fan about the axis, a fan case disposed about the fan section, an inlet to the fan case provided axially forward of the fan case, and a noise attenuation structure that extends axially forward over the interface between the fan case and the inlet.

In a further embodiment of the foregoing, the fan section comprises a diameter D and is spaced a distance L from a highlight of the inlet with a ratio of L/D being less than about 0.6.

In a further embodiment of any of the foregoing, the noise attenuation structure comprises a cartridge removable as a single part.

In a further embodiment of any of the foregoing, the noise attenuation structure comprises a face sheet having a plurality of openings, wherein the openings comprise micro perforations.

In a further embodiment of any of the foregoing, the noise attenuation structure comprises a face sheet, the face sheet defining a continuous uninterrupted inner surface between the fan case and inlet.

In a further embodiment of any of the foregoing, the inlet comprises a lip portion defining an inner surface aft of the highlight and wherein a portion of the lop portion is provided forward of the noise attenuation structure.

In a further embodiment of any of the foregoing, wherein the second noise attenuation structure is provided in the highlight.

A nacelle for as gas turbine engine assembly according to another exemplary embodiment of this disclosure, includes a fan case configured to be disposed about a fan section of the gas turbine engine, which fan section comprises a diameter D, an inlet attached to the fan case and extending axially forward of the fan case, wherein a highlight of the inlet is spaced a distance L from a region in which the fan section is configured to be disposed, wherein a ratio L/D is less than about 0.6, and a noise attenuation structure covers a portion of an inner surface of the fan case and inlet.

In a further embodiment of the foregoing, the noise attenuation structure extends axially forward over an interface between the fan case and the inlet.

In a further embodiment of any of the foregoing, the noise attenuation structure comprises a face sheet having a plurality of openings, wherein the openings comprise micro-perforations.

In a further embodiment of any of the foregoing, wherein the face sheet defines a continuous uninterrupted inner surface between the fan case and inlet.

In a further embodiment of any of the foregoing, wherein the inlet includes a lip portion defining an inner surface aft of the highlight and wherein a portion of the lip portion is provided forward of the noise attenuation structure.

In a further embodiment of any of the foregoing, wherein the second noise attenuation structure is provided in the highlight.

In a further embodiment of any of the foregoing wherein the noise attenuation structure comprises a cartridge removable as a single part.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine and nacelle.

FIG. 2 is an enlarged cross-section of the example fan section and nacelle.

FIG. 3 is a front view of the example fan section and nacelle.

FIG. 4 is a sectional view of an example noise attenuation cartridge.

FIG. 5 is a front view of the example noise attenuation cartridge separate from the nacelle.

FIG. 6 is a cross-section of an upper portion of the example nacelle.

### DETAILED DESCRIPTION

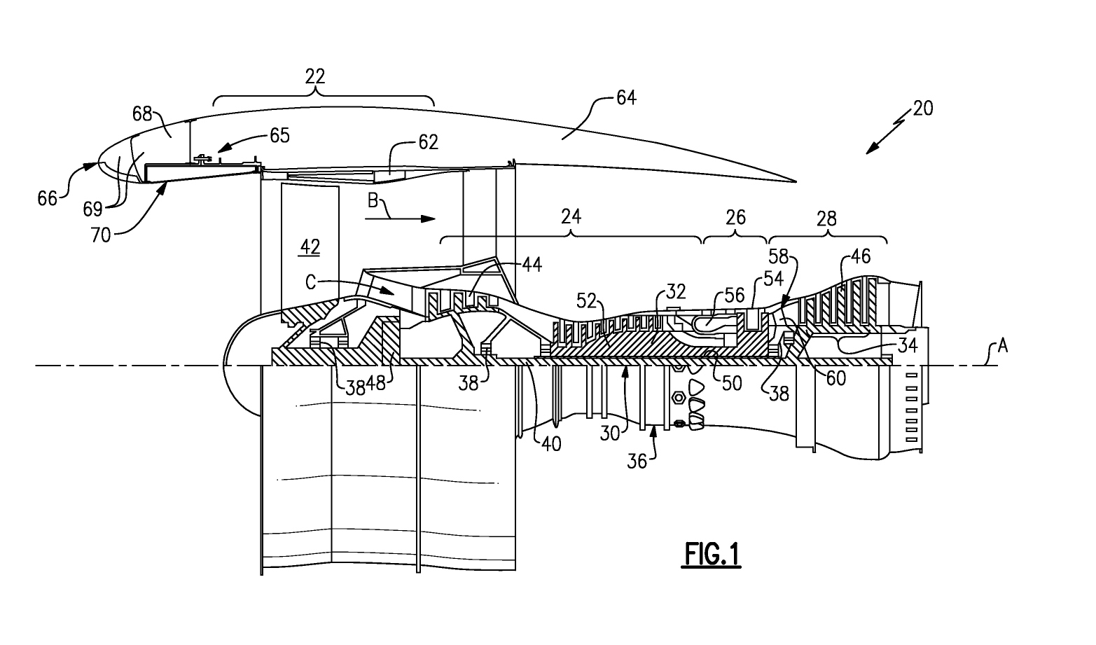

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram °R)/518.7)^{0.5}]. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors 34. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

The fan section 22 is surrounded by a fan case 62. The fan case 62 is a rigid structure that provides for mounting of the engine to a mounting structure such as an aircraft pylon. The example fan case 62 is an integrated part of the nacelle 64. The nacelle 64 defines the bypass flow path B through the fan section 22. The example nacelle 64 includes an inlet 69 that includes a lip portion 68 and a highlight 66. The highlight is a term recognized by those skilled in the art that refers to the forward most point of the nacelle 64. In the disclosed nacelle 64, the lip portion 68 is attached to the fan case 62 at an axially forward position. Adjacent the fan case 62 and the lip portion 68 is a noise attenuation cartridge 70. The noise attenuation cartridge 70 extends across an interface 65 at which the fan case 62 is adjoined to the lip portion 68.

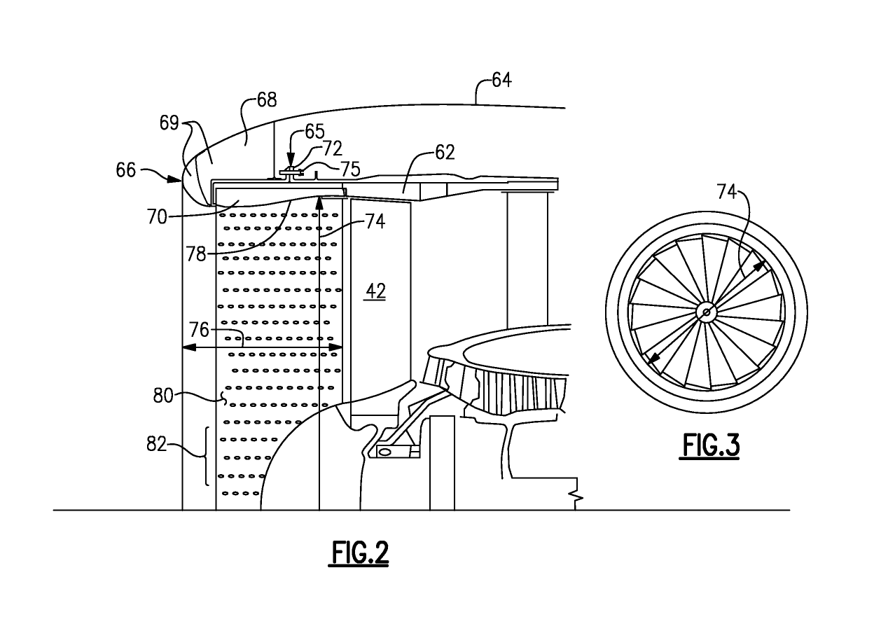

Referring to FIGS. 2 and 3, the example nacelle 64 includes the lip portion 68 and is attached to the fan case 62 at the interface 65. The example interface 65 comprises an “A” flange 72. The “A” flange 72 includes openings for a plurality of fasteners 75 (only one shown) that secure the lip portion 68 to the fan case 62. The lip 68 extends axially forward from the fan section 22 a distance 76. As appreciated, the fan section 22 includes a diameter 74 that reflects an overall diameter of the fan section 22. The example nacelle 64 is provided as a short inlet nacelle structure. The short inlet nacelle structure includes a ratio of the length (L) 76 between the highlight 66 and a leading edge of the fan blades 42 to the diameter (D) 74 of the fan section 22. A disclosed example ratio L/D is less than about 0.6.

The shortened inlet distance 76 between the highlight 66 and the leading edge of the fan 42 produces challenges for noise attenuation of the fan section 22. In this example, the distance 76 between the fan blade 42 and the highlight 66 includes the noise attenuation cartridge 70. The noise attenuation cartridge 70 includes a face sheet 80 that defines an inner surface 78 of the nacelle structure 64. The inner surface 78 defines the air flow path along the outer diameter of the fan section 22. The example noise attenuation cartridge 70 comprises a single removable part. The noise attenuation cartridge 70 further overlaps a portion of the fan case 62 and the lip region 68 by overlapping the interface 65 that includes the “A” flange 72.

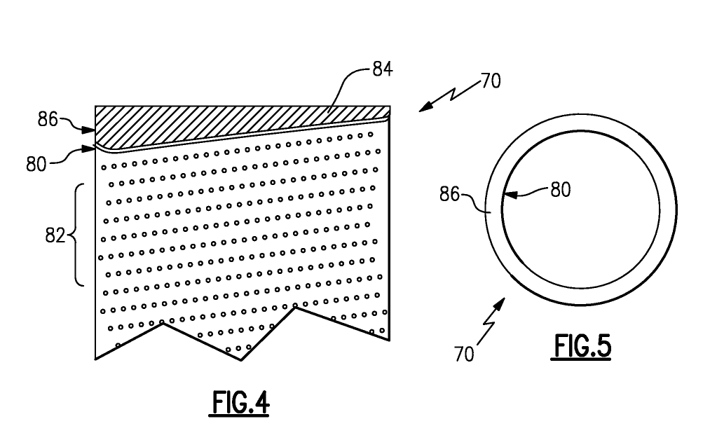

Referring to FIGS. 4 and 5 with continued reference to FIGS. 2 and 3, the example noise attenuation cartridge 70 includes a face sheet 80 that covers a cellular structure 86. The example cellular structure 86 comprises a plurality of cells 84 that are in communication with a plurality of openings 82 within the face sheet 80. The example cartridge 70 comprises a single unitary structure that can be removed from the nacelle 64 as a single, unitary part. Moreover, the face sheet 80 of the example noise attenuation cartridge 70 includes a continuous surface that is not interrupted with seams or other joints. By providing a face sheet 80 that includes no joints or interruptions, noise attenuation properties of the example noise attenuation structure 70 are improved.

The example face sheet 80 includes openings 82 to communicate sound energy to the underlying cellular structure 86 to attenuate noise without adverse affects on aerodynamic performance. In this example, the openings 82 are micro-perforations. As appreciated, although the example noise attenuation structure 70 includes a plurality of micro-perforations 82 other opening sizes and areas could be utilized to provide the desired acoustic performance of the example noise attenuation cartridge 70.

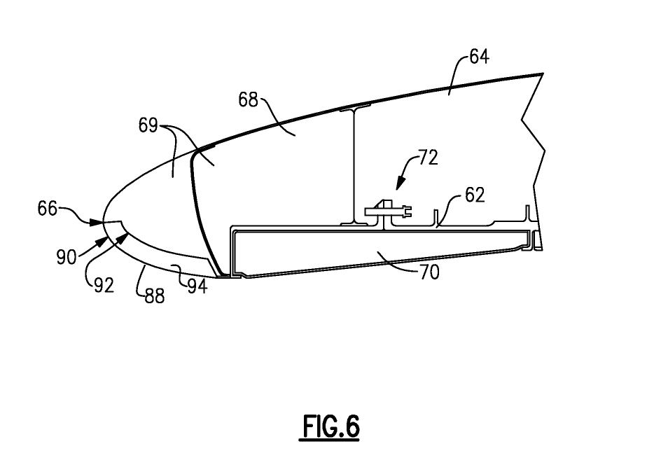

Referring to FIG. 6, another disclosed example nacelle 64 includes the noise attenuation cartridge 70 and also includes a second noise attenuation structure 88. The second noise attenuation structure 88 is disposed at a position just aft of the highlight 66. In the disclosed example, the second noise attenuation structure 88 is disposed forward of the lip region 68 and extends forward to the highlight point 66. The addition of the second noise attenuation structure 88 provides additional noise attenuation performance to the nacelle 64. In this example, the second noise attenuation structure 88 includes an outer face sheet 90 and an inner surface face sheet 92. Disposed between the inner and outer face sheets 90, 92 is a noise attenuation cellular layer 94. The example second noise attenuation structure 88 in combination with the noise attenuation cartridge 70 provides the disclosed short inlet nacelle 64 with noise attenuation performance of a nacelle with a longer inlet distance.

Accordingly, the example noise attenuation structure embodiments provide for increased noise attenuation performance for a nacelle having a shortened inlet.

Although an example embodiment has been disclosed, a worker of ordinary skill in this art would recognize that certain modifications would come within the scope of this disclosure. For that reason, the following claims should be studied to determine the scope and content of this disclosure.

1. A gas turbine engine assembly comprising:
a fan section including a plurality of fan blades rotatable about an axis;
a compressor section;
a combustor in fluid communication with the compressor section;
a turbine section in fluid communication with the combustor;
a speed change system drivable by the turbine section for rotating the fan about the axis;
a fan case disposed about the fan section;
a nacelle surrounding the fan case and including an inlet attached to the fan case axially forward of the fan case; and
a noise attenuation structure that extends axially forward over an interface between the fan case and the inlet, wherein the noise attenuation structure comprises a cartridge removable from the fan case with a radial thickness that increases in an axially forward direction.

2. The gas turbine engine assembly as recited in claim 1, wherein the fan section comprises a diameter D and is spaced a distance L from a highlight of the inlet with a ratio of L/D being less than about 0.6.

3. The gas turbine engine assembly as recited in claim 1, wherein the noise attenuation structure cartridge is removable as a single part.

4. The gas turbine engine assembly as recited in claim 1, wherein the noise attenuation structure comprises a face sheet having a plurality of openings, wherein the openings comprise micro-perforations.

5. The gas turbine engine assembly as recited in claim 1, wherein the noise attenuation structure comprises a face sheet, the face sheet defining a continuous uninterrupted inner surface between the fan case and inlet.

6. The gas turbine engine assembly as recited in claim 2, wherein the inlet comprises a lip portion defining an inner surface aft of the highlight, and wherein a portion of the lip portion is provided forward of the noise attenuation structure.

7. The gas turbine engine assembly as recited in claim 6, further comprising a second noise attenuation structure provided in the highlight.

8. A nacelle for a gas turbine engine, the nacelle comprising:
a fan case configured to be disposed about a fan section of the gas turbine engine, the fan section comprises a diameter D;
an inlet attached to the fan case and extending axially forward of the fan case, wherein a highlight of the inlet is spaced a distance L from a region in which the fan section is configured to be disposed, wherein a ratio L/D is greater than zero and less than about 0.6; and
a noise attenuation structure covers a portion of an inner surface (78) of the fan case and inlet.

9. The nacelle as recited in claim 8, wherein the noise attenuation structure extends axially forward over an interface between the fan case and the inlet.

10. The nacelle as recited in claim 9, wherein the noise attenuation structure comprises a face sheet having a plurality of openings, and wherein the openings comprise micro-perforations.

11. The nacelle as recited in claim 10, wherein the face sheet defines a continuous uninterrupted inner surface between the fan case and inlet.

12. The nacelle as recited in claim 9, wherein the inlet comprises a lip portion defining an inner surface aft of the highlight and wherein a portion of the lip portion is provided forward of the noise attenuation structure.

13. The nacelle as recited in claim 12, further comprising a second noise attenuation structure provided in the highlight.

14. The nacelle according to claim 8, wherein the noise attenuation structure comprises a cartridge removable as a single part.

15. The nacelle as recited in claim 8, wherein the noise attenuation structure includes a radial thickness that increases in an axially forward direction toward the highlight.
